(19) United States
(12) Patent Application Publication
(10) Pub. No.: US 2025/0176671 A1
(43) Pub. Date: Jun. 5, 2025

(54) Shoe Sole And Manufacturing Method Thereof

(71) Applicant: Jeong Min PARK, Seoul (KR)

(72) Inventor: Jeong Min PARK, Seoul (KR)

(21) Appl. No.: 17/769,646

(22) PCT Filed: Dec. 17, 2020
(86) PCT No.: PCT/KR2020/095150

§ 371 Date: Mar. 22, 2024

(30) Foreign Application Priority Data
Dec. 18, 2019 (KR) 10-2019-0170028

(51) Int. Cl. A43B 17/03; A43B 7/142; B29D 35/12

(52) U.S. Cl. CPC A43B 17/03; A43B 7/142; B29D 35/122

(57) ABSTRACT

The present invention relates to a shoe sole and manufacturing method thereof, wherein the shoe insole comprises: a body that is formed by a space support so as to be inserted into a shoe and support at least a portion of a sole; and a finishing band that is joined along an open edge of the body to the circumference of the body so as close the open edge and allows a filler to be injected into an inner space of the body. Since the finishing band is closely lap joined along the open edge of the body by fusing, a joint part between the finishing band and the body receives a shearing force even when the pressure inside the body is increased by injecting the filler into the body, and thus the compressive strength of the joint part can be significantly increased. Accordingly, the sealing performance of the joint part can be further improved, and thus the usable life or performance of the shoe insole can be significantly improved.

### TECHNICAL FIELD

The present invention relates to a shoe sole and manufacturing method thereof, and more particularly, to a shoe insole in which when an open edge of the circumference of a body is finished by a finishing band so as to inject a filler such as air in the body formed by a space support, a joint part of the body and the finishing band which are in contact with each other to be joined maintains the sealing performance in spite of the increase of the pressure of an inner space in the body due to the injection of the filler so that a high quality having a high elasticity may be maintained even in a long-term use and a method for manufacturing the shoe insole.

### BACKGROUND ART

Generally, a shoe insole is a product which is put in shoes such as sneakers or pumps to support a sole and for the slippers, one sole is provided and for shoes, three soles including a bottom sole, a midsole, and an inner sole are provided. Further, the shoe insole may be an insole which is additionally inserted into the finished shoes in addition to three soles. Alternatively, the insole may also be used as the same meaning as the inner sole.

Such shoe insoles have recently been developed to manufacture an air insole having an elasticity by filling inside of a cover with air, thereby increasing walking cushioning performance and wearability. For example, there is a shoe insole (Korean Registered Patent No. 10-1597112) denoted by reference numeral 101 in FIG. 1. As illustrated in the drawing, the shoe insole 101 includes a body 103 formed of a space fabric in which upper and lower piece fabrics 131 and 132 are connected by a plurality of microfibers 135 located therebetween and upper and lower waterproof panels 105 and 106 joined to cover an upper portion and a lower portion of the body 103. Upper and lower waterproof fabrics 151 and 152 are applied on inner peripheral surfaces of the upper and lower waterproof panels 105 and 106 to waterproof the upper and lower piece fabrics 131 and 132 while being fused with the upper and lower piece fabrics 131 and 132.

In order to finish the body 103 cut to have a predetermined exterior appearance, as illustrated in FIG. 1 (A), upper and lower surfaces of the body 103 are covered with the upper and lower waterproof panels 105 and 106 such that the upper and lower waterproof fabrics 151 and 152 are in contact with the upper and lower piece fabrics 131 and 132. At this time, the upper and lower waterproof panels 105 and 106 are formed to be larger than the body 103 so that edges 153 and 154 of the upper and lower waterproof panels 105 and 106 are in direct contact with each other. In this state, the upper and lower waterproof panels 105 and 106 are vertically pressed to be thermally fused, the upper and lower piece fabrics 131 and 132 are joined with inner circumferential surfaces of the upper and lower waterproof panels 105 and 106 by the melted upper and lower waterproof fabrics 151 and 152 and the edges 153 and 154 of the upper and lower waterproof panels 105 and 106 which are in direct contact with each other are joined together. Accordingly, the open edge of the body 103 is sealed and finished by the edges 153 and 154 to be joined.

However, after finishing the body 103 as described above, the shoe insole 101 is formed to apply a high pressure to an inner space by injecting a filler such as air in the inner space of the body 103 through an air injecting port 107 illustrated in FIG. 1(B). Since the edges 153 and 154 of the upper and lower waterproof panels 105 and 106 are in contact with each other to be joined by a fin sealing manner, a tension is applied to the joint part of the edges 153 and 154 by an internal pressure so that the adhesion between the edges 153 and 154 is weakened due to the long-time use and the filler is leaked to the outside, which may cause the reduction or losing of the entire elasticity of the shoe insole 101.

Further, the edges 153 and 154 of the upper and lower waterproof panels 105 and 106 are fused and the upper and lower waterproof panels 105 and 106 having a relatively large area are fused to the upper and lower piece fabrics 131 and 132, respectively, so that there is a problem in that the fused joint is unevenly performed so that the joint quality is degraded.

Further, as illustrated in FIG. 1(B), the air injecting port 107 needs to be installed between the edges 153 and 154 of the upper and lower waterproof panels 105 and 106 so that the edges 153 and 154 need to be fused while disposing the air injecting port 107 between the edges 153 and 154. Therefore, the fusing between the edges 153 and 154 is interrupted by the air injecting port 107 so that the overall sealing performance is weakened and it is significantly difficult to maintain the sealing state in this portion.

### DISCLOSURE

### Technical Problem

The present invention is proposed to solve the problems of the shoe insole of the related art and an object is to prolong an usable life of a shoe insole having an elasticity by injecting a filler such as air in a body formed of a space fabric by enhancing a joining quality of the body and a finishing band and improving a sealing performance between the body and the finishing band when an open edge portion of the body made by cutting a space fabric is finished with the finishing band so as to support at least a portion of a sole and a filler is injected therein to allow the body to have an elasticity.

Further, another object is to increase a joining quality by minimizing an area of the body and the finishing band which are directly fused by a fuser when the body and the finishing band are fused to increase concentration of the thermal fusion and increase an usable life of the shoe insole by improving the sealing performance of the body and the finishing band.

Further, still another object is to prevent degradation of the joining performance due to the filler injecting port when the body and the finishing band are joined or degradation of the sealing performance between the body and the finishing band, by integrally forming the filler injecting port with the finishing band when the finishing band is formed.

### Technical Solution

In order to achieve the above-described objects, the present invention provides a shoe insole including: a body which is formed by a space fabric so as to be inserted into a shoe and support at least a portion of a sole; and a finishing band which is joined along the edge to the circumference of the body so as to finish the open edge of the body and inject a filler into an inner space of the body.

Further, the finishing band is preferably overlap-sealed to the edge to be joined.

Further, when the finishing band is overlap-sealed to the edge, one end on a cross section is closely joined to an upper skin of the body and the other end on the cross section is closely joined to a lower skin of the body.

Further, when the finishing band is overlap-sealed to the edge, the finishing band is bent to have a cross-sectional U shape to form an upper piece closely joined to an upper skin of the body, a lower piece closely joined to a lower skin of the body, and a middle piece which connects the upper piece and the lower piece between the upper piece and the lower piece.

Further, the body is preferably formed by the space fabric to have an entirely open circumference and the band is formed to have a ring shape to finish the open edge of the body.

Further, the finishing body preferably includes a filler injecting unit which is integrally formed before being joined to the edge.

Further, the finishing band preferably includes an arch support portion which is inflated to support an arch of a sole when the filler is injected and the body is recessed as much as a space in the shoe occupied by the inflated arch support portion.

Further, the present invention provides a method for manufacturing a shoe insole including: a body cutting step of cutting a space fabric according to a shape of at least a portion of a sole to make a body; a finishing band forming step of forming a finishing band according to an open edge of the body made in the body cutting step; and a finishing band joining step of joining the finishing band along the edge to finish the edge.

Further, the finishing band joining step and the finishing band joining step are preferably combined to simultaneously form the finishing band and join the finishing band and the body by insert molding which forms the finishing band after inserting the body in a mold in advance.

### Effects of the Invention

According to the shoe sole and manufacturing method thereof the present invention, the space fabric is cut to have a shape which supports at least a portion of the sole to make a body and an open edge of the body is finished by a finishing band which is separately manufactured so that only the joint part is intensively thermally fused to significantly improve the fusion quality and the sealing performance thereby.

Further, as described above, the body and the finishing band are separately manufactured so that when the finishing band is formed by injection molding, a filler injecting unit is inserted to be integrally formed. Therefore, the open edge of the body is joined by the fusing, the filler injecting unit does not need to be joined together so that the usable life or the performance of the shoe insole may be further improved without concerning about the degradation of the fusion quality of the shoe insole due to the filler injecting unit or the degradation of the sealing performance.

Further, when the body and the finishing band are joined, the finishing band is overlap-sealed along the open edge of the body by fusing so that even though the high pressure is applied to the inner space of the body finished by the finishing band due to the filler, a shearing force is applied to the joint part in which the finishing band and the body are thermally fused and the compressive strength of the joint part is significantly increased as compared with a joint part by the fin sealing method by which the joint part is applied with the tension due to the internal pressure. Accordingly, the sealing performance of the joint part is further improved so that the usable life or the performance of the shoe insole may be significantly improved.

Furthermore, when a width of a portion of the finishing band corresponding to the arch of the sole is formed to be large and a width of the corresponding body is formed to be narrow as much as the increased width of the finishing band, if the filler is inserted into the body, the widened portion of the finishing band is inflated. Therefore, the inflated portion, that is, an arch support unit elastically supports the arch of the foot so that even though the space fabric is used, the wearability of the shoe insole may be further improved by the arch support unit.

### BRIEF DESCRIPTION OF DRAWINGS

FIG. 1 is a partial enlarged cross-sectional view illustrating a shoe insole of the related art.

FIG. 2 is a perspective view of a shoe insole according to an exemplary embodiment of the present invention.

FIG. 3 is a cross-sectional view of FIG. 2.

FIG. 4 is a perspective view of a shoe insole according to another exemplary embodiment of the present invention.

FIG. 5 is a cross-sectional view illustrating a shoe insole according to another exemplary embodiment of the present invention and a usage state thereof.

FIG. 6 is a cross-sectional view illustrating a shoe insole according to still another exemplary embodiment of the present invention and a usage state thereof.

FIG. 7 is a perspective view of a finishing band illustrated in FIG. 5.

FIG. 8 is a perspective view of a shoe insole of FIG. 5.

FIGS. 9 to 11 are views sequentially illustrating a manufacturing step of a shoe insole according to an exemplary embodiment of the present invention, in which FIG. 9 illustrates a body cutting step, FIG. 10 illustrates a finishing band forming step, and FIG. 11 illustrates a finishing band joining step.

FIG. 12 is a plan view explaining a process of separating a finishing band from a core in the finishing band forming step of FIG. 10.

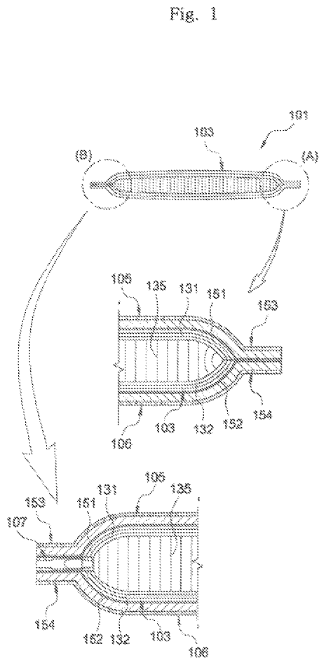

### BEST MODE FOR CARRYING OUT THE PRESENT INVENTION

Hereinafter, a shoe insole according to an exemplary embodiment of the present invention will be described in detail with reference to the accompanying drawings.

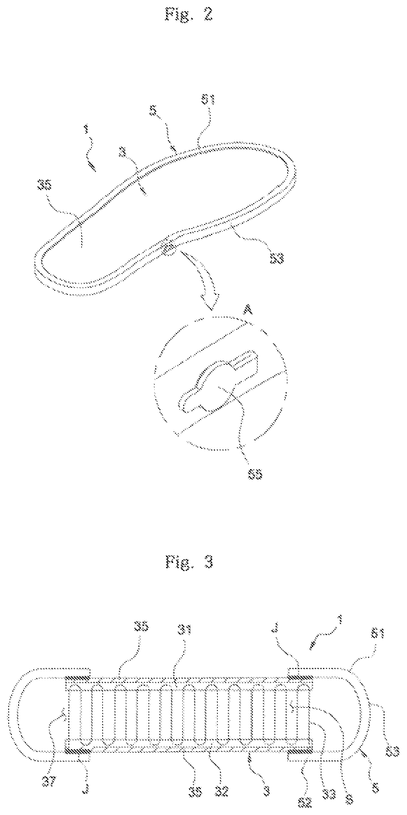

As denoted by reference numeral 1 in FIG. 2, the shoe insole of the present invention mainly includes a body 3 and a finishing band 5.

Here, the body 3 is a main part of the shoe insole 1 and is inserted into a shoe to directly support a sole of a user who puts on the shoes and as illustrated in FIG. 2, has the same or similar shape as a bottom sole, a midsole, or an inner sole so as to cover the entire bottom surface in the shoe or as illustrated in FIG. 3, has a shape like a height increase insole which supports the heel to cover a portion of the bottom surface in the shoe.

Further, the body 3 of the present invention is formed by a space fabric. That is, as illustrated in FIG. 9, the space fabric is cut to have a predetermined appropriate size to form the body. At this time, the space fabric is a three-dimensional fabric which is called a drop stitch fabric or a double Rachel fabric and as illustrated in FIGS. 2 and 3, is configured by an upper skin 31, a lower skin 32, and a plurality of pile yarns 33 which extends to a space between the upper skin 31 and the lower skin 32 to connect the upper skin 31 and the lower skin 32.

Accordingly, as illustrated in FIG. 3, in the space fabric, even though an internal pressure is increased in a state in which air or other gas receive gas or gel type fluid in an inner space S formed therebetween in a state in which an open part 37 of the edge is sealed and finished, the inflation of the upper skin 31 and the lower skin 32 is limited due to the tension and the length of the pile yarns 33.

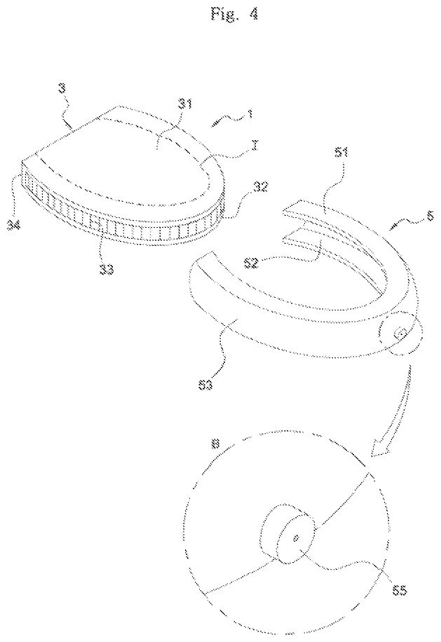

However, as another exemplary embodiment, as illustrated in FIG. 4, in the body 3, the upper skin 31 and the lower skin 32 may be connected as one by a connecting unit 34 therebetween and at this time, only a portion of the edge of the body 3 is open so that only the open edge portion needs to be finished by the finishing band 5.

Since the body 3 is formed of the space fabric as described above, as illustrated in FIG. 3, a coating layer 35 for sealing is applied on surfaces of the upper skin 31 and/or the lower skin 32 to be integrally formed.

As mentioned above, the finishing band 5 is a member which finishes the open edge of the body 3 and as illustrated in FIGS. 2 and 3, is joined along the open edge of the body 3. That is, the finishing band is joined along the circumference of the space fabric which forms the body 3 to seal and finish the open part 37 formed in the circumference. At this time, a size, a shape, or a material of the finishing band 5 is not limited and as long as it seals the inner space S of the body 3 by finishing the open part 37, anything can be applied. However, the finishing band 5 is preferably manufactured of a high elastic material such as elastomer.

Further, when the finishing band 5 seals the open edge of the body 3 as described above, the finishing band 5 can be joined along the edge in any methods. Accordingly, the finishing band 5 is joined to the circumference of the body 3 to finish the open edge so that a filler such as air is filled in the inner space S of the body 3 or air and a soft gel or a bead type foaming agent are filled together to maintain the sealed state.

However, the finishing band 5 may be formed to form a closed curve or an open curve along a length of the open edge portion of the body 3. That is, in most cases, as illustrated in FIG. 2, the body 3 is formed by cutting the space fabric along a shape of the sole or the heel so that since the open part 37 is formed along the edge of the entire circumference of the body 3, the finishing band 5 which finishes it may have a ring shaped closed curve. However, the upper and lower skins 31 and 32 of the space fabric which forms the body 3 are integrally connected by the connecting unit 34 at a part thereof as illustrated in FIG. 4, the finishing band 5 which finishes the open edge of the body 3 may form a rod shaped open curve as illustrated in FIG. 4.

Specifically, according to the exemplary embodiment, the finishing band 5 is preferably joined along the open edge of the body 3 in an overlap seal manner. To this end, one end of the finishing band 5 on a cross section is overlap-sealed along an open edge of an upper piece of the body 3 and the other end on the cross-section is overlap-sealed along an open edge of a lower piece 52 of the body 3 to finish the open edge of the body 3. In this case, the finishing band 5 may be bent to have various cross-sectional shapes such as a cross-sectional V shape, or a wavy shape. Specifically, as illustrated in FIGS. 2 to 4, when the finishing band is bent to have a cross-sectional U shape, the upper piece 51 located above the shoe insole 1 is closely joined to the upper skin 31 of the body 3 and the lower piece 52 therebelow is closely joined to the lower skin 32 of the body 3 to be overlap-sealed to the edge of the body 3 and a middle piece 53 connects the upper piece 51 and the lower piece 52 between the upper piece 51 and the lower piece 52. At this time, as illustrated in FIG. 3, the middle piece 53 may have a convex curve or a straight line shape. Further, the upper piece 51 and the lower piece 52 may be closely joined to the body 3 by various methods such as ultrasonic fusion or hot air fusion, and specifically, preferably joined by the high frequency fusion.

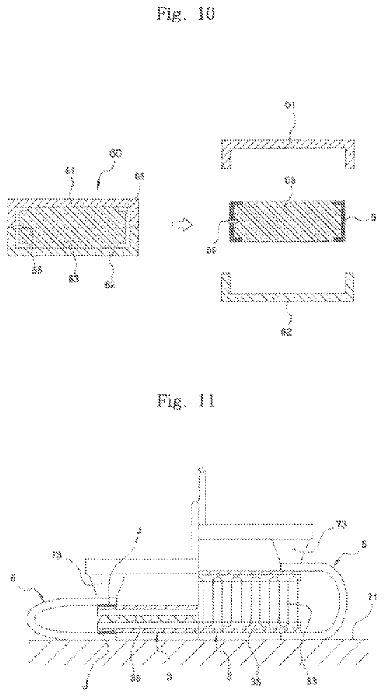

In the meantime, the finishing band 5 may include a filler injecting unit 55 at one side of the middle piece 53 to inject a filler such as air into the inner space S from the outside, after finishing the open edge with the finishing band 5. To this end, as illustrated in FIG. 10, the finishing band 5 is preferably manufactured by insert molding, so that the filler injecting unit 55 is set in advance in a mold and then formed to simply integrally form the filler injecting unit 55. As this time, as illustrated in an enlarged view of FIG. 2(A), the filler injecting unit 55 may employ a general push valve which is used for a tube used to play in the water. Further, as illustrated in an enlarged view of FIG. 4(B), an air injecting port having a small diameter used to inject air into soccer balls may also be employed. However, the filler injecting unit 55 is preferably provided in an arch part having a spatial margin as illustrated in FIG. 2 so as to minimize the interference with the inner space of the shoe when the shoe insole 1 is used.

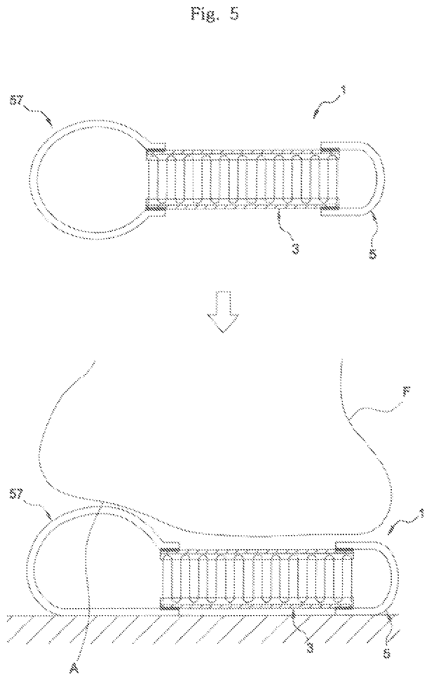

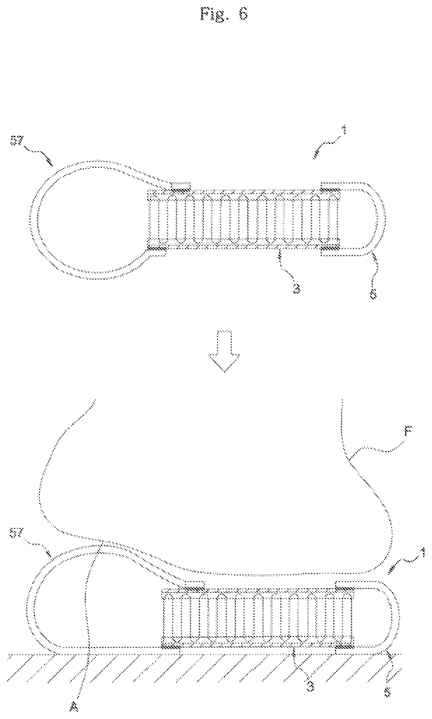

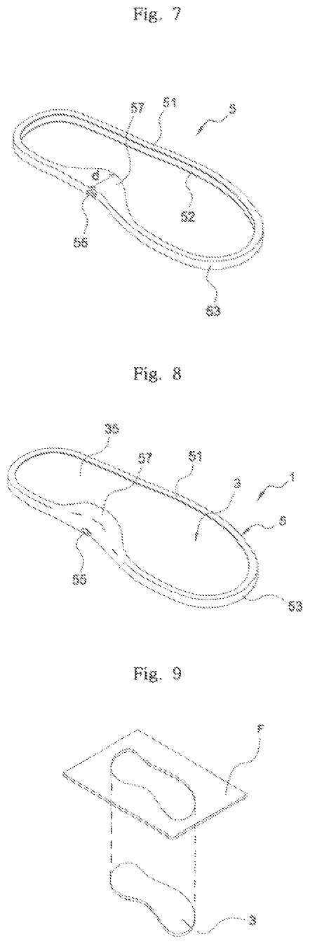

As another exemplary embodiment, the finishing band 5 may have an arch support unit 57 which supports an arch A of the sole of the foot F, as illustrated in FIGS. 5 to 7. The arch support unit 57 is formed in a portion corresponding to the arch of the sole when the shoe insole 1 is put on the shoe. Further, the arch support unit 57 may be formed to be inflated as illustrated in FIGS. 5 and 6 such that a horizontal width d of the upper piece 51 and the lower piece 52 have a sufficient margin to be larger than the other part as much as an arch width. At this time, a corresponding part of the body 3 is concavely recessed as much as an increased horizontal width d of the upper and lower pieces 51 and 52 of the arch support unit 57 or a space in the shoe occupied by the inflated arch support unit 57 as illustrated in FIG. 8. Accordingly, as the filler is injected into the inner space S after being joined to the body 3, the arch support unit 57 is inflated as illustrated in FIGS. 5 and 6 to protrude so as to support the arch of the sole as illustrated in FIG. 8. At this time, the upper piece 51 of the arch support unit 57 of FIG. 6 is deeply inserted toward the center of the body 3 more than the lower piece 52 to be joined so that when it is inflated, the arch support unit 57 of FIG. 6 is similar to a shape of the arch of the sole more than the arch support unit 57 of FIG. 5.

Now, an application of the shoe insole 1 according to an exemplary embodiment of the present disclosure will be described below according to a manufacturing method.

In order to manufacture a shoe insole of the present invention, as illustrated in FIG. 9, a support fabric F is cut according to a shape of at least a portion of a sole to make a body 3 (S10). As described above, the cut body 3 forms a coating layer 35 on surfaces of upper and lower skins 31 and 32 to increase a sealing force of the upper and lower skins 31 and 32.

Next, as illustrated in FIG. 10, a finishing band 5 which finishes an open edge of the body 3 made in the above body cutting step S10 is formed according to a shape of the edge of the body 3 (S20).

At this time, the forming is performed through an injection molding 60 illustrated in FIG. 10. In a state in which a core 63 is placed between upper and lower molds 61 and 62 and a filler injecting unit 55 is disposed at one side of a cavity 65, a molten material is poured in the cavity 65 and then cooled, and then as illustrated in FIG. 10, the upper and lower molds 61 and 62 are separated, and then separated from the core 63 therein so that the finishing band 5 which is integrally formed with the filler injecting unit 55 may be simply manufactured.

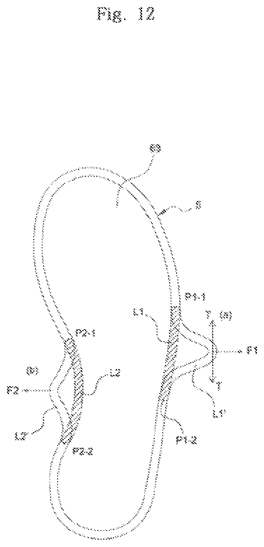

However, as illustrated in FIG. 12, in order to separate the finishing band 5 from the core 63, the finishing band 5 needs to be peeled off from the core 63. Therefore, as illustrated in FIG. 12(a), when an inner circumferential shape of the finishing band 5, that is, an outer circumferential shape of the core 63 is flat to be almost close to a straight line, if the finishing band 5 is held to be pulled by applying a force F1 to the outside of the radial direction, an original length L1 between a point P1-1 and a point P1-2 is elongated to a length L1′ as the finishing band is pulled to the direction of the force F1 so that a strong tension is generated due to the elasticity of the finishing band 5. Accordingly, it is very difficult to pull the finishing band 5 to be elongated like a length L1′ portion and consequently, the method of pulling the length L1 portion to separate the finishing band 5 from the core 63 follows a lot of difficulties.

In contrast, when the inner circumferential shape of the finishing band 5 is recessed as illustrated in FIG. 12(b), if the finishing band 5 is held to be pulled by applying a force F2 to the outside of the radial direction, the length L2′ pulled to the direction of the force F2 is gradually shorter than the original length L2 between the point P2-1 and P2-2 until the length L2′ reaches the straight distance between the point P2-1 and the point P2-2 and maintains to be shorter than the original length L2 until the length L2′ is the same as the original length L2 so that even though the finishing band is pulled with the force F2, the tension is not additionally generated in the finishing band. Accordingly, of the finishing band 5 is not elongated until the length between the point P2-1 and the point P2-2 which are separated from the core 63 by being pulled with the force F2 is equal to the original length L2 between the point P2-1 and the point P2-2. Therefore, the resistance due to the tension of the finishing band 5 when it is pulled is not applied and consequently, the length L2 portion is pulled to easily separate the finishing band 5 from the core 63. By doing this, after easily separating the length L2 portion from the core 63, the finishing band 5 may be entirely easily separated from the core 63.

As described above, after forming the finishing band 5 in the finishing band forming step S20, as illustrated in FIG. 11, the finishing band 5 is joined along the edge of the body 3 by various joining methods such as high frequency fusion to finish the edge (S30).

To this end, the body 3 is disposed in a ring shaped finishing band 5 first such that as illustrated in FIG. 11, edge portions of the inner circumferential surfaces of the upper and lower pieces 51 and 52 of the finishing band 5 is overlapped with edge portions on the surfaces of the upper and lower skins 31 and 32 of the body 3 by a predetermined width or more. Thereafter, a provisionally joined body 3 and finishing band 5 are placed on a jig 71 and an overlapped portion of the body 3 and the finishing band 5 are pressed to join the contact portion of the outer edge of the body 3 and the inner edge of the finishing band 5 as a joint part J in an overlap sealing manner. Accordingly, after finishing the open edge of the body 3 by the finishing band 5, a high pressure filler is injected into the inner space S so that even though the internal pressure in the inner space S is increased, the joint part is applied with a shearing force. Therefore, as compared with the joint part by a fin sealing method of the related art which is applied with a tension due to the increase of the internal pressure, the sealing performance may be significantly improved.

At this time, since the coating layer 35 is formed on a surface of the edge of the body 3 in the contact portion, the edge of the body 3 is strongly joined to the edge of the finishing band 5 in the contact portion by the thermal fusion. However, the pile yarn 33 which is not heated by the high frequency wave is interposed between the upper and lower skins 32 of the body 3 inwardly adjacent to the contact portion so that the upper and lower skins are not joined and thereafter are easily separated when the filler is injected in the inner space S.

By doing this, when the joining of the body 3 and the finishing band 5 is completed, the filler such as air is injected into the inner space S through the filler injecting unit 55 to complete a highly elastic shoe insole 1.

In the meantime, the finishing band forming step S20 and the finishing band joining step S33 are integrated as one step of insert molding. To this end, after inserting the body 3 in the mold for forming the finishing band in advance, the molten material is injected to form the finishing band 5 so that the finishing band 5 is formed and joined along the open edge of the body 3 by the overlap sealing to finish the shoe insole 1 at one time.

### INDUSTRIAL APPLICABILITY

According to the shoe sole and manufacturing method thereof, the space fabric is cut to have a shape which supports at least a portion of the sole to make a body and an open edge of the body is finished by a separately manufactured finishing band so that only the contact portion is intensively thermally welded and thus the fusion quality and the sealing performance thereby may be significantly improved.

1. A shoe insole, comprising:
a body 3 which is formed by a space fabric so as to be inserted into a shoe and support at least a portion of a sole; and
a finishing band 5 which is joined along the edge to the circumference of the body 3 so as to finish an open edge of the body 3 and inject a filler into an inner space S of the body 3.

2. The shoe insole of claim 1, wherein the finishing band 5 is overlap-sealed to the edge to be joined.

3. The shoe insole of claim 2, wherein when the finishing band 5 is overlap-sealed to the edge, one end on a cross section is closely joined to an upper skin 31 of the body 3 and the other end on the cross section is closely joined to a lower skin 32 of the body 3.

4. The shoe insole of claim 2, wherein when the finishing band 5 is overlap-sealed to the edge, the finishing band 5 is bent to have a cross-sectional U shape to have an upper piece 51 closely joined to an upper skin 31 of the body 3; a lower piece 52 closely joined to a lower skin 32 of the body 3; and a middle piece 53 which connects the upper piece 51 and the lower piece 52 between the upper piece 51 and the lower piece 52.

5. The shoe insole of any one of claims 1 to 4, wherein the body 3 is formed by the space fabric having an entirely open circumference and the band 5 is formed to have a ring shape to finish the open edge of the body 3.

6. The shoe insole of claim 5, wherein the finishing body 5 includes a filler injecting unit 55 which is integrally formed before being joined to the edge.

7. The shoe insole of claim 5, wherein the finishing band 5 includes an arch support unit 57 which is inflated to support an arch of a sole when the filler is injected and the body 3 is recessed as much as a space in the shoe occupied by the inflated arch support portion 57.

8. A method for manufacturing a shoe insole, comprising:
a body cutting step S10 of cutting a space fabric according to a shape of at least a part of a sole to make a body 3;
a finishing band forming step S20 of forming a finishing band 5 according to an open edge of the body 3 made in the body cutting step S10; and
a finishing band joining step S30 of joining the finishing band 5 along the edge to finish the edge.

9. The method for manufacturing a shoe insole of claim 8, wherein the finishing band joining step S30 and the finishing band joining step S30 are combined to simultaneously form the finishing band 5 and join the finishing band 5 and the body 3 by insert molding which forms the finishing band 5 after inserting the body 3 in a mold in advance.
